(19) United States
(12) Patent Application Publication
(10) Pub. No.: US 2014/0229563 A1
(43) Pub. Date: Aug. 14, 2014

(54) MOBILE PERSONAL BASE STATION HAVING CONTENT CACHING FUNCTION AND METHOD FOR PROVIDING SERVICE BY THE SAME

(71) Applicant: Electronics and Telecommunications Research Institute, Daejeon (KR)

(72) Inventors: Sook Yang KANG, Daejeon (KR); Jaesheung SHIN, Daejeon (KR); Eunah KIM, Daejeon (KR); Hyun Seo PARK, Daejeon (KR); Sung-Min OH, Daejeon (KR); Ae-Soon PARK, Daejeon (KR); Pyeong Jung SONG, Daejeon (KR)

(73) Assignee: Electronics and Telecommunications Research Institute, Daejeon (KR)

(21) Appl. No.: 14/090,878

(22) Filed: Nov. 26, 2013

(30) Foreign Application Priority Data
Feb. 14, 2013 (KR) 10-2013-0016034

(51) Int. Cl. H04L 29/08

(52) U.S. Cl. CPC H04L 67/1097; H04L 67/06; H04L 67/04
USPC 709/213

(57) ABSTRACT

A mobile personal base station having a caching function and a method for providing service by the same are disclosed. The mobile personal base station is connected to a service provision server, downloads and stores content, and then broadcasts the availability of the service corresponding to the content to a neighboring terminal. Upon receiving a service request from the neighboring terminal, the mobile personal base station provides the downloaded and stored content to the neighboring terminal.

### CROSS-REFERENCE TO RELATED APPLICATION

This application claims priority to and the benefit of Korean Patent Application No. 10-2013-0016034 filed in the Korean Intellectual Property Office on Feb. 14, 2013, the entire contents of which are incorporated herein by reference.

### BACKGROUND OF THE INVENTION

(a) Field of the Invention

The present invention relates to a mobile personal base station having a content caching function and a method for providing service by the same.

(b) Description of the Related Art

With the advent of smartphones, mobile communication service has evolved from data consisting mostly of voice to large-capacity multimedia data, which contributes to the rapid increase in mobile traffic. Moreover, mobile service providers are suggesting new network structures and new service architectures in order to provide high-quality service to users.

To cope with the rapid growth in traffic, much attention is being paid to the deployment of a plurality of small cells such as femtocells. Also, various methods such as the deployment of small cells in such a manner so as to overlap macrocells or the distribution of WiFi networks and traffic have been proposed. As for the configuration of small cells, fixed base stations are deployed in proximity to users, and service is provided by connection to a wired IP network through a wired backhaul for the fixed base stations.

With the fixed base stations, however, installation space is occupied, and it is difficult to be flexible in responding to network conditions. In addition, users tend to offload a large amount of traffic in business districts in a downtown area during the daytime, while they tend to offload a large amount of traffic in residential areas after work, which renders traffic distribution dynamic. Hence, there is a need for a flexible network that enables a dynamic cell configuration.

Another method for coping with the rapid growth in traffic includes CDN (Contents Delivery Network) technology. CDN is a technology that stores content in a cache server and allows the cache server to respond to a content request because it takes a lot of time when a user wants to download content from a server at a remote location. The CDN can serve content even with the occurrence of a service failure caused by data traffic congestion or a bottleneck by deploying service provision servers in a distributed fashion. However, even the CDN technology needs to evolve to keep pace with the advent of dynamic content, large-capacity content, and cloud service in mobile environments.

Currently, 60 to 70% of traffic in mobile environments is video traffic, and more than 30% of users reportedly download the same traffic. This means that networks are suffering from massive overloads to serve the same data.

### SUMMARY OF THE INVENTION

The present invention has been made in an effort to provide a mobile personal base station which increases network capacity and enables dynamic network configuration, and a method for providing service by the same.

An exemplary embodiment of the present invention provides a method for providing service by a mobile personal base station connected to a service provision server. The method may include: equipping the mobile personal base station with a caching function; connecting to the service provision server and downloading and storing content from the service provision server; broadcasting the service corresponding to the content to a terminal neighboring the mobile personal base station; and upon receiving a service request from the terminal, providing the terminal with a first content corresponding to the requested service, among the downloaded content.

The mobile personal base station may be connected to the service provision server through a base station and a gateway, and the downloading and storing may include connecting to the service provision server through the base station and the gateway, and downloading and storing content from the service provision server.

The broadcasting may be performed through resources allocated from the base station.

The first content may be provided on a location basis or service area basis.

The providing of the first content to the terminal may be performed by the mobile personal base station without connecting to the service provision server.

The mobile personal base station may include a cloud server function.

Another exemplary embodiment of the present invention provides a mobile personal base station. The mobile personal base station may include: a service connection controller that establishes a connection to a service provision server; a content storage and repository manager that stores content transmitted from the service provision server through the connection; and a service opening/detection unit that broadcasts the service corresponding to a content to a neighboring terminal, wherein upon receiving a request for a first service from the neighboring terminal, a content corresponding to the first service among the stored content may be provided to the neighboring terminal.

The connection to the service provision server may be established by a base station, a gateway, and the service provision server.

The content corresponding to the first service may be provided on a location basis or service area basis.

The mobile personal base station may further include: a terminal-to-terminal direct communication controller that allocates a local bearer to enable direct communication between terminals connected to the base station; a radio resource controller that allocates resources for wireless connection; and an adaptive streaming control technology unit that converts resolution or CODECs depending on capability of the neighboring terminal.

According to an exemplary embodiment of the present invention, a mobile personal base station is equipped with a caching function to build a local network, thereby increasing network capacity and enabling a dynamic network configuration. That is, a service provider is able to cut network investment costs, and a user is able to get high-quality service from a neighboring mobile personal base station.

### BRIEF DESCRIPTION OF THE DRAWINGS

FIG. 1 is a view showing a network structure in which a mobile personal base station in accordance with an exemplary embodiment of the present invention downloads content from a service provision server.

FIG. 2 is a view showing the internal configuration of the mobile personal base station in accordance with the exemplary embodiment of the present invention.

FIG. 3 is a view showing that the mobile personal base station in accordance with the exemplary embodiment of the present invention forwards its content to neighboring terminals to share the content.

FIG. 4 is a view showing a procedure of making a service request and providing service between the neighboring terminals and the mobile personal base station.

FIG. 5 is a view showing a method for providing service from a mobile personal base station having a content caching function in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “terminal” may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and so on, or may include all or some functions of the terminal, the MT, the MS, the AMS, the HR-MS, the SS, the PSS, the AT, and the UE.

Further, the term “base station” (BS) may designate an advanced base station (ABS), a high reliability base station (HR-BS), a nodeB, an evolved node B (eNodeB), an access point (AP), a radio access station (RAS), a base transceiver station (BTS), a mobile multihop relay (MMR-BS), a relay station (RS) serving as a base station, and a high reliability relay station (HR-RS) serving as a base station, and may include all or some functions of the ABS, the nodeB, the eNodeB, the AP, the RAS, the BTS, the MMR-BS, the RS, and the HR-RS.

Hereinafter, a mobile personal base station having a content caching function and a method for providing service by the same in accordance with an exemplary embodiment of the present invention will be described. The mobile personal base station in accordance with the exemplary embodiment of the present invention is a mobile cell that an individual can carry with them, and which can be referred to as a pocket cell.

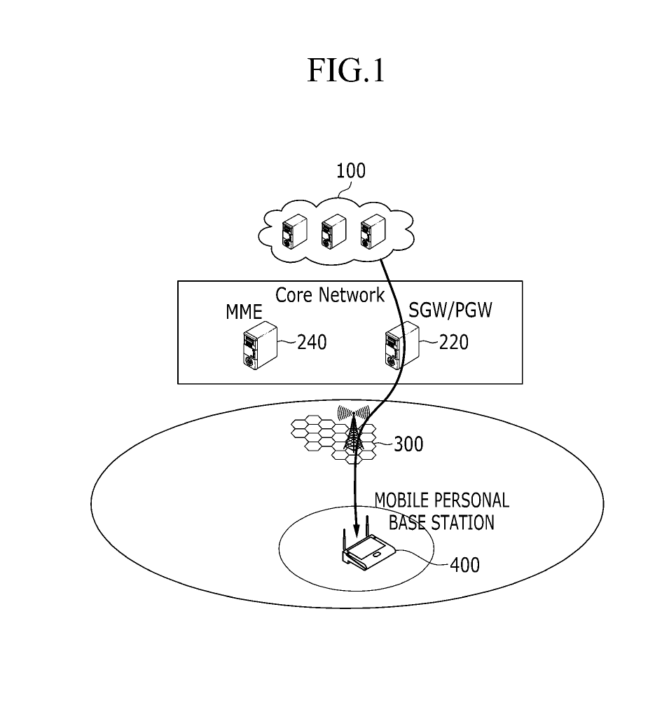

FIG. 1 is a view showing a network structure in which a mobile personal base station 400 in accordance with an exemplary embodiment of the present invention downloads content from a service provision server 100. Although the network structure and terms shown in FIG. 1 are based on LTE (Long Term Evolution), the present invention may be applied to other mobile communication structures such as future advanced mobile communication structures.

As shown in FIG. 1, the overall network structure includes a service provision server 100, a Serving Gateway/PDN Gateway (SGW/PGW) 220, an MME (Mobility Management Entity) 240, a base station 300, and a mobile personal base station 400.

The service provision server 100 serves content to the mobile personal base station 400 through the SGW/PGW 220 and the base station 300.

The SGW/PGW 220 routes data between the service provision server 100 and the mobile personal base station 400. The MME 240 is equipped with subscriber mobility management and session establishment functions, and the service provision server 100 establishes a data path between the service provision server 100 and the mobile personal base station 400 to provide service. The SGW/PGW 220 and the MME 240 form a core network.

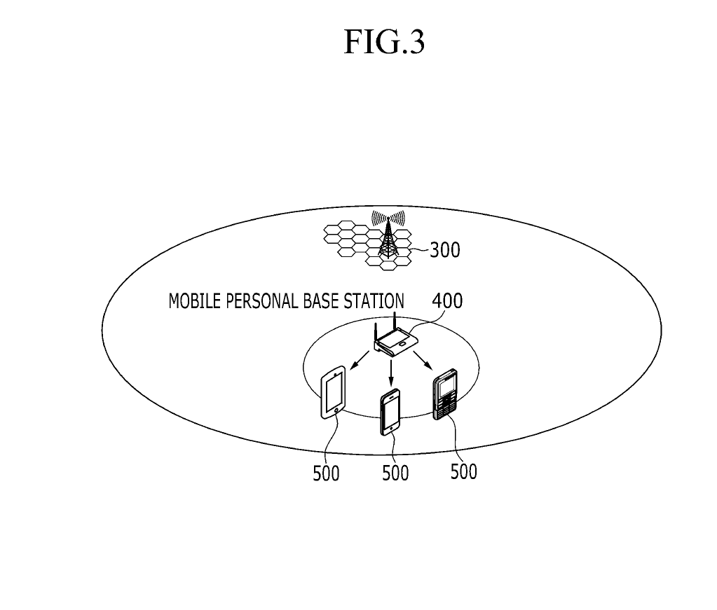

The mobile personal base station 400 in accordance with the exemplary embodiment of the present invention is equipped with a content caching function, and as shown in FIG. 1, downloads and stores content from the service provision server 100 through the SGW/PGW 220 and the base station 300. The mobile personal base station 400 serves as a cache that downloads content from the service provision server 100 and serves the content to neighboring terminals connected to the mobile personal base station 100. As shown in FIG. 3, the mobile personal base station 100 is connected to and interfaces with neighboring terminals 500.

In a conventional network structure, a service provision server is located at the back end of a core network, and provides service to a subscriber (i.e., terminal) over the core network. Also, the conventional network structure generates traffic to the network because a data path is always established, even for calls between subscribers in close proximity.

However, in the network structure in accordance with the exemplary embodiment of the present invention, as shown in FIG. 1, the mobile personal base station 400 downloads and stores content from the service provision server 100 in advance. If the mobile personal base station 400 wants to provide dynamically generated content to the neighboring terminals 500, it can provide the stored content to the neighboring terminals 500 without downloading from the service provision server 400.

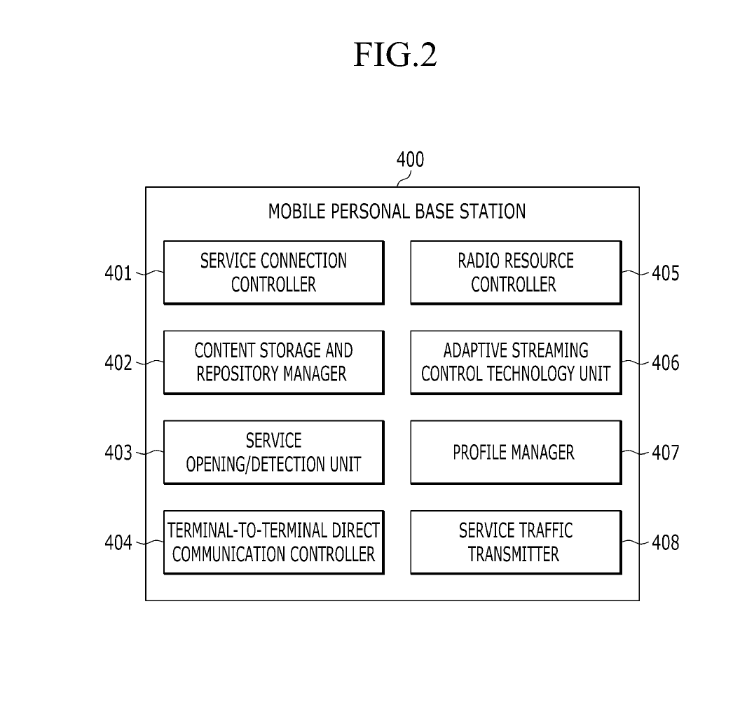

As explained above, the mobile personal base station in accordance with the exemplary embodiment of the present invention includes a caching function, i.e., a CDN function. A detailed configuration of the mobile personal base station 400 will be described in detail with reference to FIG. 2.

FIG. 2 is a view showing the internal configuration of the mobile personal base station in accordance with the exemplary embodiment of the present invention.

As shown in FIG. 2, the mobile personal base station 400 in accordance with the exemplary embodiment of the present invention includes a service connection controller 401, a content storage and repository manager 402, a service opening/detection unit 403, a terminal-to-terminal direct communication controller 404, a radio resource controller 405, an adaptive streaming control technology unit 406, a profile manager 407, and a service traffic transmitter 408.

The service connection controller 401 functions to make a connection request and set up a call in order for the mobile personal base station 400 to get service from a network server, i.e., the service provision server 100. Moreover, the service connection controller 401 makes service connection and disconnection requests to neighboring terminals 500 wanting to get the content that the mobile personal base station 400 has downloaded.

The content storage and repository manager 402 functions to store various types of content received from the service provision server 100 and self-generated content and label services.

The service opening/detection unit 403 functions to broadcast the content downloaded from the service provision server 100 so that the neighboring terminals 500 can use the content.

The terminal-to-terminal direct communication controller 404 functions to allocate and control a local bearer to enable direct communication between terminals connected to the base station 300.

The radio resource controller 405 functions to allocate and schedule resources for wireless connections.

The adaptive streaming control technology unit 406 functions to convert resolution or CODECs depending on the capability of the neighboring terminal 500, by which the terminals 500 will receive services without any additional equipment or functionality.

The terminal profile manager 407 manages a database of the capabilities or information of terminals connected to service to provide service properly.

The service traffic transmitter 408 functions to forward user plane data so that data is transmitted through a traffic path established by a control message.

As explained above, if the mobile personal base station 400 in accordance with the exemplary embodiment of the present invention wants to provide dynamically generated content to the neighboring terminals 500, it provides the content directly to the terminals 500, as shown in FIG. 3, without downloading from the service provision server 100. Examples of dynamic content provision include the provision of specific services from the mobile personal base station 400 on a location basis or service area basis, such as amusement parks, department stores, museums, etc.

FIG. 3 is a view showing that the mobile personal base station 400 in accordance with the exemplary embodiment of the present invention forwards its content to neighboring terminals 500 to share the content.

As shown in FIG. 3, the mobile personal base station 400 in accordance with the exemplary embodiment of the present invention broadcasts to and opens its services in the neighboring terminals 500 through resources allocated from the base station 300 or given specific resources. That is, the mobile personal base station 400 provides its services to the neighboring terminals 500 through allocated resources to broadcast it.

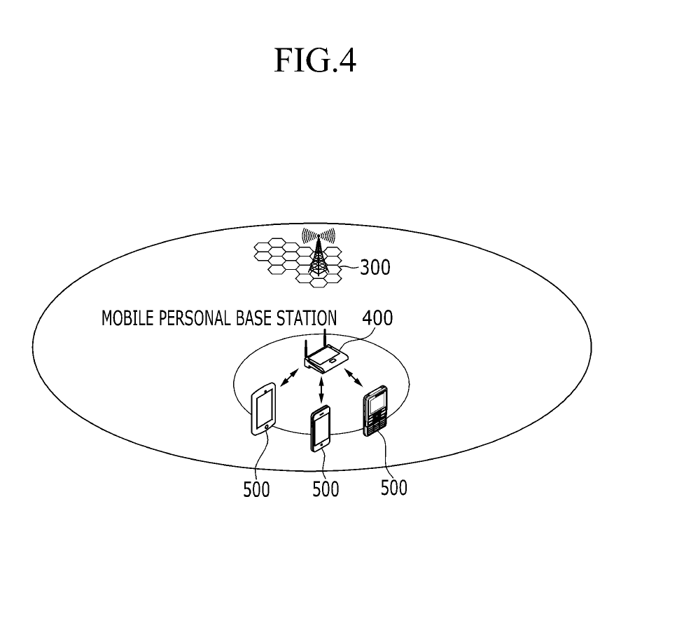

FIG. 4 is a view showing a procedure of making a service request and providing service between the neighboring terminals 500 and the mobile personal base station 400.

As shown in FIG. 3, upon receiving a service broadcast from the personal base station 400, a terminal 500 checks whether desired service content exists in the broadcast information. As shown in FIG. 4, if the desired service content exists, the terminal 500 makes a service request to the mobile personal base station 400, and the mobile personal base station 400 provides dynamically generated content to the neighboring terminal 500. That is, as shown in FIG. 4, the neighboring terminal 500 can establish a direct service path to the mobile personal base station 400, and get service without forming a network among the base station 300, the SGW/PGW 220, and the service provision server 100.

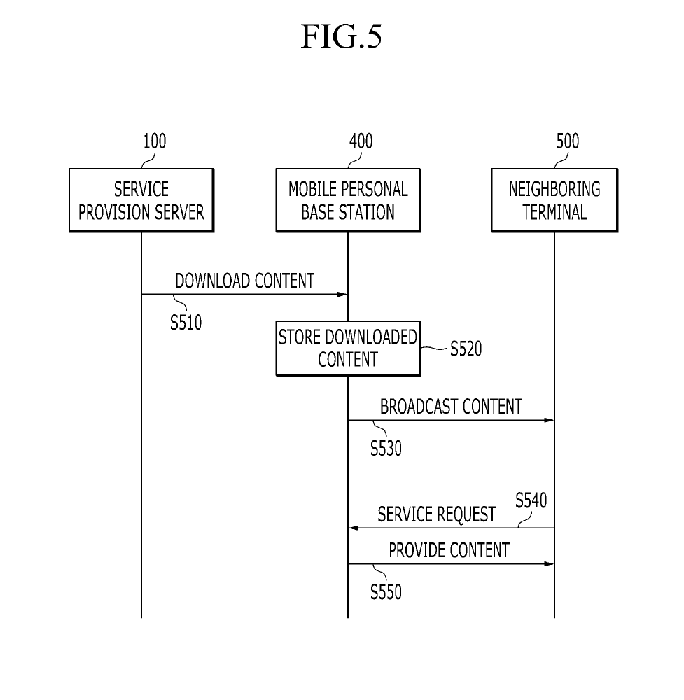

FIG. 5 is a view showing a method for providing service from a mobile personal base station 400 having a content caching function in accordance with an exemplary embodiment of the present invention.

First, the mobile personal base station 400 downloads content in advance from the service provision server 100 through the base station 300 and the SGW/PGW 220 (S510). That is, the mobile personal base station 400 in accordance with the exemplary embodiment of the present invention downloads content in advance from the service provision server 100, in order to serve as a cache to serve content to a neighboring terminal 500.

The mobile personal base station 400 stores the content downloaded from the service provision server 100 (S520). Such a storage function is performed by the content storage and repository manager 402 of the mobile personal base station 400.

Next, the mobile personal base station 400 broadcasts its services (i.e., items of the downloaded content) to the neighboring terminal 500 (S530). Such a broadcasting function is performed by the service opening/detection unit 402 of the mobile personal base station 400. As such, the neighboring terminal 500 is able to know the content of the service provided from the mobile personal base station 400, and checks whether desired service content exists.

Next, if the mobile personal base station 400 has a desired service, the neighboring terminal 500 makes a service request to the mobile personal base station 400 (S540).

Upon receiving a service request from the neighboring terminal 500, the mobile personal base station 400 provides the content downloaded from the service provision server 500 to the neighboring terminal 500. That is, the neighboring terminal 500 can get service directly from the mobile personal base station 400, without forming a network among the base station 300, the SGW/PGW 220, and the service provision server 100.

In accordance with the exemplary embodiment of the present invention, a network is formed around the mobile personal base station 400 to provide dynamic localized services. A service user, i.e., the neighboring terminal 500, can get fast and convenient services at a low cost through local traffic processing.

While the foregoing description has been made with respect to a mobile personal base station 400 having a content caching function in accordance with an exemplary embodiment of the present invention, it will be apparent to those skilled in the art that the present invention is also applicable to a mobile personal base station 400 having a cloud server function.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing service by a mobile personal base station connected to a service provision server, the method comprising:
equipping the mobile personal base station with a caching function;
connecting to the service provision server, and downloading and storing content from the service provision server;
broadcasting the service corresponding to the content to a terminal neighboring the mobile personal base station; and
upon receiving a service request from the terminal, providing the terminal with a first content corresponding to the requested service among the downloaded content.

2. The method of claim 1, wherein the mobile personal base station is connected to the service provision server through a base station and a gateway, and the downloading and storing comprises connecting to the service provision server through the base station and the gateway, and downloading and storing content from the service provision server.

3. The method of claim 2, wherein the broadcasting is performed through resources allocated from the base station.

4. The method of claim 1, wherein the first content is provided on a location basis or service area basis.

5. The method of claim 1, wherein the providing of the first content to the terminal is performed by the mobile personal base station without connecting to the service provision server.

6. The method of claim 1, wherein the mobile personal base station comprises a cloud server function.

7. A mobile personal base station comprising:
a service connection controller that establishes a connection to a service provision server;
a content storage and repository manager that stores content transmitted from the service provision server through the connection; and
a service opening/detection unit that broadcasts a service corresponding to the content to a neighboring terminal,
wherein upon receiving a request for a first service from the neighboring terminal, a content corresponding to the first service among the stored content is provided to the neighboring terminal.

8. The mobile personal base station of claim 7, wherein the connection to the service provision server is established by a base station, a gateway, and the service provision server.

9. The mobile personal base station of claim 7, wherein the content corresponding to the first service is provided on a location basis or service area basis.

10. The mobile personal base station of claim 7, further comprising:
a terminal-to-terminal direct communication controller that allocates a local bearer to enable direct communication between terminals connected to the base station;
a radio resource controller that allocates resources for wireless connection; and
an adaptive streaming control technology unit that converts resolution or CODECs depending on capability of the neighboring terminal.
